(19) United States
(12) Patent Application Publication
(10) Pub. No.: US 2007/0192194 A1
(43) Pub. Date: Aug. 16, 2007

(54) Metalevel electronic marketplace for advertising

(76) Inventors: Michael O'Donnell, Issaquah, WA (US); Jonathan Peterson, Evanston, IL (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/707,695

(22) Filed: Feb. 16, 2007

Related U.S. Application Data
(60) Provisional application No. 60/774,112, filed on Feb. 16, 2006.

(51) Int. Cl. G06Q 30/00

(52) U.S. Cl. 705/14

(57) ABSTRACT

A method using an intermediary electronic marketplace for sourcing advertisements from multiple advertisement suppliers that use an electronic marketplace to acquire, select, and place electronic advertisements and providing the advertisements to publishers. By operating as an intermediary, the method can automatically compare prices of advertisements from multiple sources, allowing effective price competition, and the method can provide a third party check to verify that proper payment is made to each publisher.

### BACKGROUND

The advent of the Internet and other distribution mediums for digital content has spawned new ways for advertisers to reach users of content. One such popular application is called “paid search.” When users conduct a search, the search engine not only returns results based on the user's query, but also displays sponsored advertising links that are related to the search query made by the user. For example, when entering the search term “SUV” into a search engine, the user sees a list of sponsored links on the right side of the web page that displays the results of the search. Advertisers pay the search engine for these links. When the user clicks any of the sponsored links, the search engine collects a “per click” charge from the advertisers. Advertisers, in competition with other advertisers for space on the web page that displays the results of the search, “bid” on the per click rate. For example, one advertiser may be willing to pay $1.00 per click for the term “SUV,” while another advertiser may be willing to pay only $0.10 per click for the term “Sports Utility Vehicle.” Once the advertisers have submitted their ads, the bidding all takes place automatically via computer networks as the search engine selects which ads to display to users. Herein, such an automatic system is called an “electronic marketplace”.

This business model using such an electronic marketplace is frequently called, “Keyword Advertising.” Another form of this business model involves displaying advertisements based on the web sites that users visit and the products that they buy. Another form of advertising called “Behavioral Advertising” uses the internet browsing history of users to select appropriate ads. Yet a different form of this business model, called “Contextual Advertising,” involves displaying text ads and image ads on web pages based on the type of content published and the audience profile of the visitors. All of these business models for advertising are implemented using an electronic marketplace, in which advertisers submit bids to an ad network, in competition with other advertisers, for display to users who will read and hopefully respond to the ads.

Whether paid search, keyword advertising, behavioral advertising, or contextual advertising, the goal—for both advertiser and ad network—is to (a) display ads that are most relevant to the interests and activities of the user; and (b) to allow the user to instantly respond to the ads by clicking, calling, or taking some other action. This same business model is applied to content published on mobile phones, portable music players, and other devices. In other words, this type of advertising is not just used by search engines to attract advertisers: it is also used by content publishers, device makers, and other parties with valuable content real estate (collectively herein “content publishers”) to attract more advertisers and, in some cases, charge more for the ad insertions.

From their perspective, advertisers are typically willing to pay more to advertise on search engines and on publisher web sites using an electronic marketplace than they are more conventional forms of ad placement. This type of advertising promises to deliver them a highly qualified audience for their ads and they often pay only when a user takes an action, such as clicking on their ad. These electronic marketplaces for advertising also provide advertisers with detailed information on the efficacy of their campaigns.

Much as physical real estate provides property developers with space on which to build buildings, publisher web sites and digital devices provide advertisers “real estate” with space on which to advertise. As a result of this new real estate, and because advertisers are motivated to buy this real estate over conventional forms of ad placements, dozens of new electronic marketplace ad networks have sprung up to sell ads on this real estate. Companies such as Google, Yahoo Publisher Network (formerly called Overture), MIVA, Marchex, Quigo, and Industry Brains, have sprung up to sell contextual ads, keyword ads, and behavioral ads, and place them within search engines, web pages, and devices that accommodate digital content using an electronic marketplace. Additionally, traditional advertising agencies such as J Walter Thompson and Saatchi and Saatchi have begun to offer their clients the ability to place their ads on this real estate using an electronic marketplace.

The content publishers can receive automatic ad placement for a single spot from only one ad network—one supplier of keyword, contextual and/or behavioral advertisements—and therefore can tap only the advertisers who have placed ads with that network, despite the fact that other, more relevant (and therefore more lucrative) ads may have been in the inventory of another network. There is currently no practical, automatic method for a content publisher to aggregate and use ads from multiple sources. In fact, many ad networks contractually or technically force ad recipients to display whatever ads are sent them, sometimes to the detriment of the recipient (for example, if an advertiser is a competitor of the content publisher, or if association with the advertiser is for any reason undesirable). After selecting an ad network, the content publishers have little control, and increasingly settle for a smaller share of the ad dollars collected by these ad networks and ad agencies.

Neither are advertisers well served by the current state of affairs, as there is currently no practical, automatic method for an advertiser to reach multiple content publishers if they happen to have selected different ad networks. An advertiser wishing to place ads on content publishers' real estate independent of ad network selection is either prevented from reaching those valuable readers, or is forced to contract with multiple ad networks to reach them all. This increases the advertiser's operational burden and management costs, and makes it more difficult to track a campaign's effectiveness.

### SUMMARY OF THE INVENTION

The invention is a system and method that accepts ads, in a variety of formats and via a variety of delivery mechanisms, from a plurality of electronic marketplace ad sources, then, using an intermediary electronic marketplace, automatically reformats them to a common format, filters them, ranks them, and places them on, within or near the targeted real estate, based on specific criteria. The criteria are defined by the company that operates the intermediary electronic marketplace for the content publishers, by the content publishers themselves, and by the context in which the ads are rendered (i.e, an email, a web page, a printed page, a mobile phone display, and so on).

In one aspect, for any single advertisement, the invented system makes it possible for content publishers to choose from the largest available pool of ads at any given moment in time. Ads often have a very limited “shelf life” when appearing on search results, web pages, within content, or in other digital forms (collectively herein “context”), because advertisers often bid for advertising space with a defined and limited budget. As soon as this budget is expended from users clicking on their ads, calling the ads, or acting on them in some other way, the ads disappear from the available pool. The invention aggregates feeds from multiple electronic marketplace ad networks, placements from ad agencies, the content publisher's own ad sales team or house account, and from other sources. It makes it possible for content publishers and other owners of valuable ad real estate to access the largest possible pool of available advertisements, automatically, in real time.

In another aspect, the invented system allows the content publisher to maximize the value from each ad placed. There is only so much room on a search results page, web page, article, or mobile phone display. Only a small number of ads can reasonably be presented to a user at one time. The invention makes it possible to place the ads that deliver the most amount of value to the content publisher. For example, if only six ads can reasonably be placed within an article displayed on a web page, the invention can ensure that the most valuable six ads are selected above all other ads that may be relevant. It does this in two ways: first, the invention knows how much per click, or call, or impression, each ad pays the content publisher; and second, it knows what percentage split the seller of the ad is giving to the content publisher. For example, an ad that pays $2 per click is typically more valuable than an ad that pays $1 per click. However, if the ad supplier of the $2 per click ad shares 20% of the ad revenue with the content publisher, and the ad supplier of the $1 per click ad shares 50%, the invented method would rank the $1.00 per click ad higher, because it will deliver more revenue to the content publisher if clicked. In this respect, as an intermediary electronic marketplace, the invention is an arbiter of advertising electronic marketplaces.

In another aspect, the invented system allows the sourcing, filtering, ranking, and placement system to ascertain the most relevant ads, based on the keywords, subject of the content, user profile, and other criteria, from multiple sources. (See “Selecting and Pricing Advertising for Passed Along Content” U.S. patent application Ser. No. 11/599,243, filed by the same inventors on Nov. 13, 2006, which is incorporated by reference.) Even if an ad paid $10 per click, it may not be placed on the real estate if it is less relevant to the content or the interests of the user than an ad paying $8 per click, but which was judged as being more likely to be clicked. The invented system includes a prior art algorithm that determines which ads, and which types of ads from all the possible sources vying to be inserted, are the most relevant for the given context. In performing this function, the invented system does not rely on just one type of advertising, such as keyword advertising. The system can also make use of contextual ads (the subject of the content) and/or behavioral ads (the profile of the intended viewer).

In another aspect, the invented system can apply filters that are important to the content publishers. For example, some publishers may not wish to accept ads from certain ad networks or certain ad agencies. The system can filter out ads being made available from parties that the owner does not wish to accept. Additionally, the publisher or the owner of the real estate may not wish to insert ads from certain companies, such as competitive companies, or from certain types of ads, such as “Viagra” ads or diet ads, or ads containing specific words or phrases.

In another aspect, the invented system can perform “deduping” and integrity checking of available ads from multiple sources. For example, Google, Yahoo, MIVA and other networks may have sold the same ad to the same advertiser for the term “SUV”. The invented system can weed out duplicates so that the same ad does not appear within the real estate more than once at a time. The system can perform other integrity checks of the available ad inventory from multiple sources, as well, rejecting those that do not meet the integrity criteria. For example, it can check to see that the phone number associated with a “pay-per-call” ad is a working number; check for number of words, suitable formatting; and size of an image.

In another aspect, the invented system can record, track and report the results of the ads from multiple suppliers that appear within the real estate. For example, it can track when ads are clicked. It can record how many ads resulted in a call, or how many copies of a page a user made that included the ad. It can track how many e-mails were sent that contained the ad, and whether those recipients forwarded it on to others. It can record how long a user “saved” in a “reading room” a piece of content that included the ad. This tracking mechanism is important to ensure that the owner or publisher of the content, or other type of ad real estate, is being paid the correct amount of money from the ad supplier. It is typically the ad supplier/agent that collects the money from the advertiser and is obligated to remit a portion to the publisher/owner, who allowed the insertion of the ad. This tracking and reporting feature provides independent third-party reports to ensure accountability across multiple ad suppliers.

In greater detail, in one aspect, the invention is a method for use in a computer system to effect an intermediary electronic marketplace for a plurality of electronic marketplace advertisement sources. The method includes receiving automatically offered feeds from each of a plurality of first level electronic marketplaces for advertisements where each first level electronic marketplace received sets of data via a computer network from a plurality of electronic advertising sources. Each set of data includes a pointer to content of an offered advertisement and metadata about the advertisement which metadata may be used to determine ad placement. The first level marketplaces selected advertisements to be offered and automatically offered the advertisements to others via a computer network. With the automatically offered feeds from each of the first level electronic marketplaces for advertisements, the system bids offers from at least two electronic marketplaces against each other by receiving requests for ad placements via a computer network from a plurality of publisher computer systems that publish content to people via a computer network, each request comprising information from which a selection of an appropriate advertisement may be made. The system then uses metadata about offered advertisements from at least two first level electronic marketplaces and the information about each request to automatically match an advertisement to each request. Finally, the system transmits to each publisher computer system a pointer to content of one of the offered advertisements in response to each request for ad placement.

Where revenues from ad placements are to be split in proportions between two or more parties, the bidding process may include consideration of the proportions are used in matching an advertisement to each request. The split is typically between the publisher and the ad network that supplied the ad. Because the invented system is an intermediary, it can track the amounts that should be paid to the publisher and ensure that they are properly paid.

In this method, each pointer to content of an advertisement may point to content that accompanies the pointer or it may point a resource location in a computer network where the content is stored. The metadata about each advertisement may include a price that an advertiser is willing to pay and the information about each request may include a price that a requester is willing to accept.

The system operates in real time such that, when a request for ad placement is received, the matching step and transmitting of a pointer to content are performed without programmed delay. To avoid delay in delivery of content into which an advertisement is to be placed, the content may delivered without waiting for selection of an advertisement and then the selected advertisement is transmitted after the surrounding content has already been transmitted.

In another aspect, the invention is a method for use in a computer system to effect a merging of multiple electronic advertisement sources. The method begins with receiving sets of data via a computer network from a first electronic advertising source according to a first standard advertising data interchange protocol, and receiving sets of data via a computer network from a second electronic advertising source according to a second standard advertising data interchange protocol. Each set of data includes a pointer to content of an offered advertisement and metadata about the advertisement which metadata may be used to determine ad placement. The problem to be solved is that the first protocol is inconsistent with the second protocol and the second protocol is inconsistent with the first protocol. Therefore, the method translates the sets of data received via the first and second protocols into a single common advertisement data format.

### BRIEF DESCRIPTION OF THE FIGURES

FIG. 1 illustrates the basic components of an embodiment of the invention.

### DETAILED DESCRIPTION

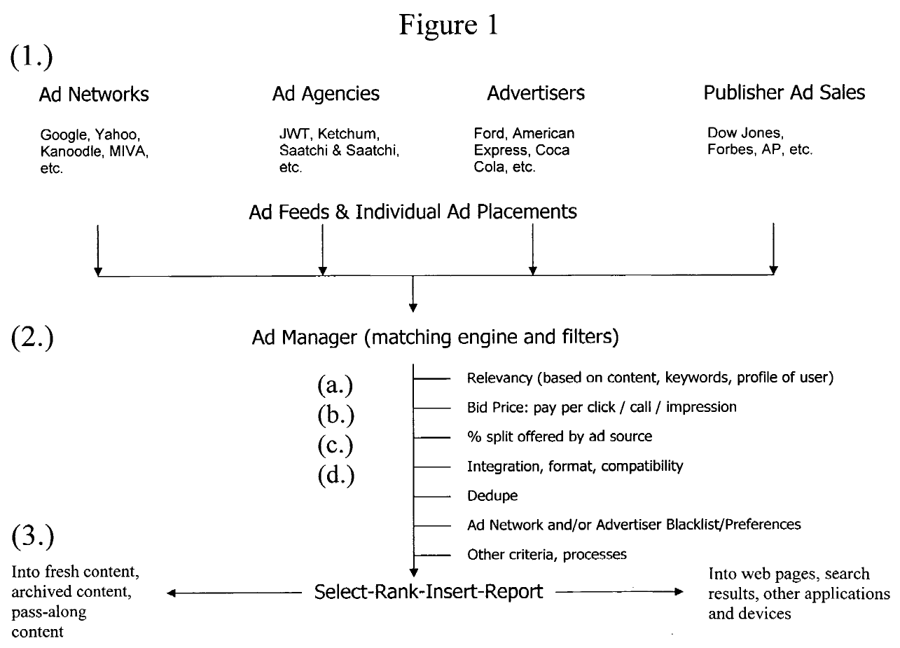

Step (1.) of FIG. 1 depicts the sourcing of advertisements. This is the aggregation step that ensures that the content publisher has access to the widest possible pool of advertisements available (and actionable) in a given moment, for a given context or application (web page, article, search query), regardless of whether the source is an ad network, an ad agency, the publisher's ad sales team, or an individual advertiser. The system provides a mechanism to receive unlimited ads for possible inclusion in the targeted real estate.

The system collects ads at the time the ads need to be displayed to a user, because of the brief “shelf life” of ads as previously described. The aggregator makes an electronic request to each ad source, either in sequence or in parallel, using the existing query mechanism specific to that ad source. For example, if an ad network offers ads to publishers via an XML query sent over HTTP, the aggregator uses a query of this form to fetch ads from that network; if an ad agency has placed ads into a database table, then the aggregator queries this database using SQL to fetch ads from that agency. On receipt of each response, the aggregator converts the response from the ad network-specific format into a generic ad format for manipulation in subsequent steps. Note that other, arbitrary ad sources can easily be added to the system, so long as the ad inventory can be described in the system's generic ad format.

Step (2.) of FIG. 1 depicts the matching and filtering techniques used by the system to ensure that the most appropriate, profitable, and relevant ads are selected for display on the content publisher's real estate. Each ad is considered in sequence, and is assigned by the system a numeric “grade” based on a variety of factors. This mechanism is described in greater detail in prior art and includes such factors as:
The revenue the ad would generate if the user acted upon it, taking into consideration not only the advertiser's bid price, but also the share of the bid price taken by the ad network that delivered it.
The relevancy of the ad to the content publisher's audience, based on keyword analysis of the ad itself.
The relevancy of the ad to the user, based on the user's previous history of clicking other ads from a particular network, or the behavior of other users who have similar ad clicking history as does the user.
The content of the ad itself, including such elements as blacklisted words or phrases, length preference, or keyword density.
Similarity to other ads returned by other ad networks (the “dedup” step, in which ads that are substantially similar to existing, otherwise higher-graded ads are given lower grades).
Other criteria requested by content publishers.

The system operators, in cooperation with the content publishers, determine the grading criteria and relative importance of those criteria. These criteria and preferences are stored in the system's configuration, most typically in a database, associated with each content publisher. A password-protected series of web pages is provided to content publishers which allow them to add, modify, and delete these criteria.

Step (3.) of FIG. 1 depicts the final selection, ranking, insertion and reporting process. In Step 2, the system may have qualified 10 ads for insertion. If the context calls for only 6 ads, four ads are dropped and six are selected based upon the “grade” assigned to each one, with the highest-graded ads being placed first The final 6 ads are then inserted in order of grade, since ads appearing at the top usually get clicked more than those appearing at the bottom. The system then must send and “insert” the selected ads into the application, whether it is a web page, an email, word processing document, device, or other application. For example, if the ads are to appear in a web page, then an appropriately formatted HTML fragment is emitted.

The system records actions taken by the users of the application, such as clicking, calling, or printing the content that contains the inserted ads. This provides accountability to ensure that the advertising supplier pays the agreed upon revenue split to the publisher/owner of the real estate in which the ads were inserted and acted upon. The mechanism by which the system secures this depends on the context in which the ads are being displayed and may vary from publisher to publisher and ad network to ad network. In one example, the “click URL” ads that are to appear in an email are modified into URLs pointing to servers running the invented system's software. When a user clicks on an ad, the system first tracks that usage, then redirects the user's browser to the ad network's site for the final redirection to the advertiser's page. In another example, the “Click URL” or “Call ad” may route directly to the ad network that supplied the ad, with a “verification copy” sent to the system operator.

Finally, this usage information is collected and aggregated for delivery to publishers, advertisers, and system operators.

The invention may be embodied with infinite variations. Thus, the scope of the invention shall be understood to be what is stated in the following claims without limitation by any particular embodiments or examples given above.

What is claimed:

1. A method for use in a computer system to effect an intermediary electronic marketplace for a plurality of electronic marketplace advertisement sources, the method comprising:
(a) receiving automatically offered feeds from each of a plurality of first level electronic marketplaces for advertisements where each first level electronic marketplace received sets of data via a computer network from a plurality of electronic advertising sources, each set of data comprising a pointer to content of an offered advertisement and metadata about the advertisement which metadata may be used to determine ad placement, selected advertisements to be offered, and automatically offered the advertisements to others via a computer network;
(b) with the automatically offered feeds from each of the first level electronic marketplaces for advertisements, bidding offers from at least two electronic marketplaces against each other by:
(c) receiving requests for ad placements via a computer network from a plurality of publisher computer systems that publish content to people via a computer network, each request comprising information from which a selection of an appropriate advertisement may be made;
(d) using metadata about offered advertisements from at least two first level electronic marketplaces and the information about each request to automatically match an advertisement to each request and
(e) transmitting to each publisher computer system a pointer to content of one of the offered advertisements in response to each request for ad placement.

2. The method of claim 1 where each pointer to content of an advertisement points to content of the advertisement that accompanies the pointer.

3. The method of claim 1 where each pointer to content of an advertisement points to a resource location in a computer network.

4. The method of claim 1 further comprising ranking the offered advertisements so, if two or more advertisements can be matched with a request, the higher ranking advertisement is placed.

5. The method of claim 1 where the metadata about each advertisement may include a price that an advertiser is willing to pay.

6. The method of claim 1 where the information about each request may include a price that a requester is willing to accept.

7. The method of claim 1 where the system operates in real time such that, when a request for ad placement is received, the matching step and transmitting of a pointer to content are performed without programmed delay.

8. The method of claim 7 where, to avoid delay in delivery of content into which an advertisement is to be placed, said content is delivered without waiting for selection of an advertisement and then the selected advertisement is transmitted after the surrounding content has already been transmitted.

9. The method of claim 1 where revenues from ad placements are to be split in proportions between two or more parties and the proportions are used in matching an advertisement to each request.

10. The method of claim 1 where the matching is based in part on past performance of at least two of the offered advertisements, each advertisement offered by a different source.

11. The method of claim 1 where the information about a request for an advertisement includes information specific to an individual person to whom the advertisement is to be presented.

12. The method of claim 11 where the information specific to an individual person includes information about what advertisements that person has responded to in the past.

13. The method of claim 12 where the computer system receives responses to advertisements and aggregates information from the responses for subsequent use in determining which advertisements should be presented to the person that responded.

14. The method of claim 1 where the matching process removes duplicates of advertisements offered from multiple sources.

15. The method of claim 1 wherein, if the advertisement includes words, the process counts one of the number of words or the number of characters to ensure that the number is within a range acceptable to the publisher.

16. The method of claim 1 wherein, if the advertisement includes an image, the process determines whether a size of the image is within a range acceptable to the publisher.

17. The method of claim 1 wherein the computer system makes a record of information about each advertisement provided in response to a request which record is available for lookup through a computer network.

18. The method of claim 1 wherein the computer system receives information about each provided advertisement that is viewed and keeps a record thereof that is available for lookup through a computer network.

19. The method of claim 1 wherein the computer system receives information about each provided advertisement that is clicked on and keeps a record thereof that is available for lookup through a computer network.

20. A method for use in a computer system to effect a merging of multiple electronic advertisement sources, the method comprising:
(a) receiving sets of data via a computer network from a first electronic advertising source according to a first standard advertising data interchange protocol, each set of data comprising a pointer to content of an offered advertisement and metadata about the advertisement which metadata may be used to determine ad placement;
(b) receiving sets of data via a computer network from a second electronic advertising source according to a second standard advertising data interchange protocol, each set of data comprising a pointer to content of an offered advertisement and metadata about the advertisement which metadata may be used to determine ad placement;
(c) where the first protocol is inconsistent with the second protocol and the second protocol is inconsistent with the first protocol;
(d) translating the sets of data received via the first and second protocols into a single common advertisement data format
(e) receiving requests for ad placements via a computer network from a plurality of publisher computer systems that publish content to people via a computer network, each request comprising information from which a selection of an appropriate advertisement may be made;
(c) using the metadata about each offered advertisement and the information about each request to automatically match an advertisement to each request and
(d) transmitting to each publisher computer system a pointer to content of an advertisement in response to each request for ad placement.

21. The method of claim 20 where the electronic advertising sources comprise two or more of: electronic marketplace ad networks, ad agencies, publishers, and individual advertisers.

22. The method of claim 20 where the first protocol is an XML query sent over HTTP and the second protocol is not XML sent over HTTP.

23. The method of claim 20 where the first protocol is an SQL database query and the second protocol is not an SQL database query.

24. The method of claim 20 where the matching process removes duplicates of advertisements offered from multiple sources.

25. A method for use in a computer system to automatically compare prices of offered ads from multiple electronic advertisement sources, the method comprising:
(a) receiving sets of data via a computer network from a first electronic advertising source, each set of data comprising a pointer to content of an offered advertisement and metadata about the advertisement which metadata may be used to determine advertisement placement where the metadata includes a price offered to be paid to a publisher for at least one of: presenting the advertisement, receiving a click from the advertisement, or receiving a telephone call to a telephone number shown in the advertisement;
(b) receiving sets of data via a computer network from a second electronic advertising source, each set of data comprising a pointer to content of an offered advertisement and metadata about the advertisement which metadata may be used to determine advertisement placement where the metadata includes a price offered to be paid to a publisher for at least one of: presenting the advertisement, receiving a click from the advertisement, or receiving a telephone call to a telephone number shown in the advertisement;
(c) receiving requests for ad placements, each request comprising information from which a selection of an appropriate advertisement may be made;
(e) using the metadata about each offered advertisement and the information about each request to automatically match an advertisement to each request; and
(f) in the matching process, considering offered prices.

26. The method of claim 25 where the electronic advertising sources comprise two or more of: electronic marketplace ad networks, ad agencies, publishers, and individual advertisers.

27. The method of claim 25 where the price information comprises both a price to be paid by an advertiser and a commission to be retained by the electronic advertising source.

28. A method for tracking and reporting to publishers performance of electronic advertising networks, comprising:
(a) on an intermediary server, receiving a request for ad placement via a computer network from a publisher computer system that publishes content to people via a computer network, the request comprising information from which a selection of an appropriate advertisement may be made;
(b) forwarding the request to a server of an electronic advertising network where the advertising network server (1) receives via a computer network from a plurality of electronic advertisers pointers to content of offered advertisements and metadata about the advertisements which metadata may be used to determine ad placement, (2) selects an advertisement from an advertiser based on information received from the intermediary server, and (3) automatically provides a pointer to content of the selected advertisement to the intermediary server;
(c) transmitting to the publisher computer system the pointer to content of the offered advertisement along with a response pointer to a tracking and reporting server which pointer is activated if a viewer of the advertisement takes an action with respect to the advertisement;
(d) on the tracking and reporting server, receiving a data set via the response pointer which data set indicates that a viewer clicked on the advertisement;
(e) forwarding information from the data set back to the electronic marketplace server;
(f) making a record of information from the data set; and
(g) reporting information from the data set to the publisher.

29. The method of claim 28 where the method is practiced with two ad network sources and data about relative performance between the two ad networks is collected and reported to publishers.

30. The method of claim 28 where the information from the data set reported to the publisher includes how much money the publisher is owed from each ad placement and from each ad network.

31. The method of claim 28 where the action taken by a viewer is to click on a hot spot on the advertisement and the pointer is a URL which leads to the tracking and reporting server.

32. The method of claim 28 where the action taken by a viewer is to place a telephone call to a telephone number shown in the advertisement and the pointer is a telephone number shown in the advertisement which leads to the tracking and reporting server and is then forwarded to a server controlled by the advertiser.

33. The method of claim 28 where the system operates in real time such that, when a request for ad placement is received, the matching step and transmitting of a pointer to content are performed without programmed delay.

34. The method of claim 33 where, to avoid delay in delivery of content into which an advertisement is to be placed, said content is delivered without waiting for selection of an advertisement and then the selected advertisement is transmitted after the surrounding content has already been transmitted.

35. The method of claim 28 where the information about each request includes whether the advertisement is requested for placement in an email, a web page, a printed page, or a mobile telephone display.
